(19) United States
(12) Patent Application Publication
(10) Pub. No.: US 2025/0231318 A1
(43) Pub. Date: Jul. 17, 2025

(54) OPTICAL SCANNING APPARATUS, OBJECT DETECTION APPARATUS

(71) Applicant: STANLEY ELECTRIC CO., LTD., Tokyo (JP)

(72) Inventors: Hiroshi KOTANI, Tokyo (JP); Atsuhiko CHIKAOKA, Tokyo (JP)

(73) Assignee: STANLEY ELECTRIC CO., LTD., Tokyo (JP)

(21) Appl. No.: 19/016,210

(22) Filed: Jan. 10, 2025

(30) Foreign Application Priority Data
Jan. 16, 2024 (JP) 2024-004461

(51) Int. Cl. G01V 8/14; G01V 8/18

(52) U.S. Cl. CPC G01V 8/14; G01V 8/18

(57) ABSTRACT

An optical scanning apparatus used for detecting an object by irradiating light and receiving the reflected light including: a deflector; a light source having a first light-emitting unit that emits a first light and a second light-emitting unit that emits a second light having optical characteristics different from that of the first light; a first optical element disposed so that the first light emitted from the first light-emitting unit is incident thereon and reflects the first light and causes it to be incident on the deflector; a second optical element disposed so that the second light emitted from the second light-emitting unit is incident thereon and reflects the second light and causes it to be incident on the deflector; where the first optical element reflects the first light and transmits the second light, and where the second optical element reflects the second light and transmits the first light.

### BACKGROUND

### Technical Field

The present disclosure relates to an optical scanning apparatus, and an object detection apparatus.

### Description of the Background Art

Prior art of an optical scanning apparatus and an object detection apparatus is described in Japanese Unexamined Patent Application Publication No. 2010-151958, for example.

In a specific aspect, it is an object of the present disclosure to further widen measurement viewing angle in an optical scanning apparatus or the like.

### SUMMARY

(1) An optical scanning apparatus according to one aspect of the present disclosure is an optical scanning apparatus used for detecting an object by irradiating light and receiving the reflected light including: a deflector; a light source having at least a first light-emitting unit that emits a first light and a second light-emitting unit that emits a second light having optical characteristics different from that of the first light; a first optical element disposed so that the first light emitted from the first light-emitting unit is incident thereon and reflects the first light and causes it to be incident on the deflector; a second optical element disposed so that the second light emitted from the second light-emitting unit is incident thereon and reflects the second light and causes it to be incident on the deflector; where the first optical element has optical characteristics of reflecting the first light and transmitting the second light, and where the second optical element has optical characteristics of reflecting the second light and transmitting the first light.

(2) An object detection apparatus according to one aspect of the present disclosure is an object detection apparatus including: an optical scanning apparatus according to the above-described (1); a light receiving unit that detects the reflected light caused by the light irradiated from the optical scanning apparatus and generates a light receiving signal corresponding to the intensity of the reflected light; and a control unit that controls the operation of the optical scanning apparatus and generates point group information based on the light receiving signal.

According to the above configurations, it is possible to further widen measurement viewing angle in an optical scanning apparatus and an object detection apparatus including the same.

### BRIEF DESCRIPTION OF THE DRAWINGS

FIG. 1 is a diagram showing the configuration of an object detection apparatus according to one embodiment.

FIG. 2 is a diagram for explaining a layout example of the scanning light source unit in a housing.

FIG. 3 is a diagram for explaining in detail the arrangement of each dichroic mirror and the MEMS mirror.

FIG. 4A and FIG. 4B are diagrams for explaining in more detail the relationship between each dichroic mirror and the trajectory of the laser light when the laser light transmits through each dichroic mirror.

FIG. 5 is a diagram showing a combination example of the transmission/reflection characteristics of each dichroic mirror and the wavelength of each light-emitting unit.

FIG. 6 is a diagram showing an example of optical calculation of the measurement field angle assuming the optical scanning apparatus of the embodiment.

FIG. 7A and FIG. 7B are diagrams for explaining in more detail the relationship between each reflective polarizer and the trajectory of the laser light when the laser light transmits through each reflective polarizer according to modified working example 1.

FIG. 8 is a diagram showing a combination example of the transmission/reflection characteristics of each reflective polarizer and the wavelength of each of the light-emitting units according to modified working example 1.

FIG. 9 is a diagram for explaining a layout example inside the housing of the scanning light source unit according to modified working example 2.

FIG. 10A to FIG. 10D are diagrams for explaining in more detail the relationship between each reflective polarizer and the trajectory of the laser light when the laser light transmits through each reflective polarizer according to modified working example 2.

FIG. 11 is a diagram showing a combination example of the transmission/reflection characteristics of each reflective polarizer and the wavelength of each light-emitting unit according to modified working example 2.

### DESCRIPTION OF THE PREFERRED EMBODIMENTS

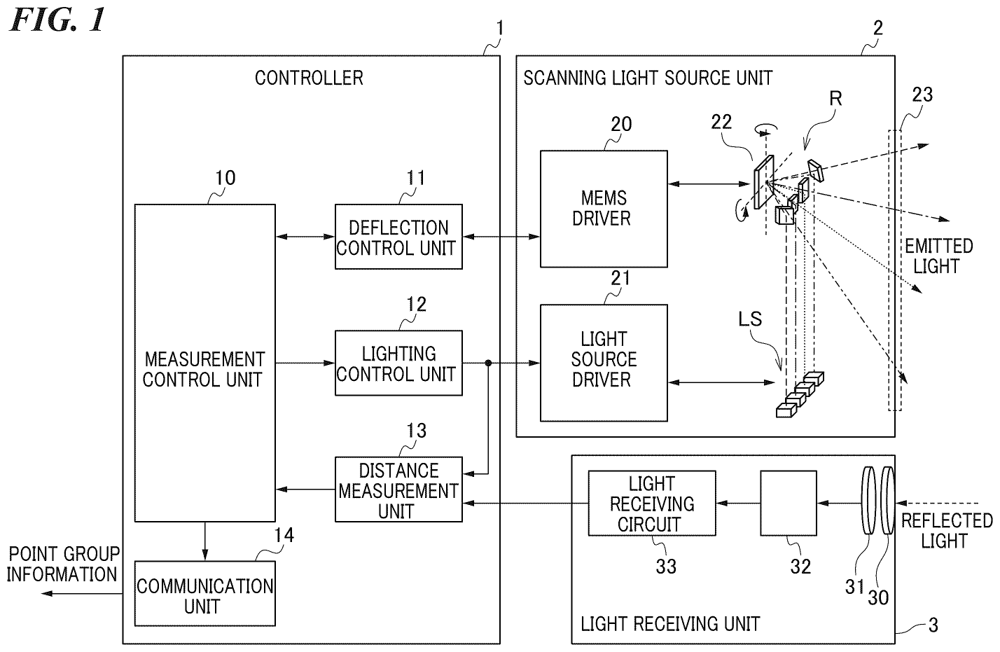

FIG. 1 is a diagram showing the configuration of an object detection apparatus according to one embodiment. The object detection apparatus according to the present embodiment uses multiple laser lights (detection lights) to perform optical scanning of a target space, receives reflected light, and uses the reflected light to detect point group information indicating the position and relative distance of an object present in the target space, and is configured to include a controller 1, a scanning light source unit (optical scanning apparatus) 2, and a light receiving unit 3.

This object detection apparatus is mounted on a vehicle and used to detect objects around the vehicle (other vehicles, pedestrians, etc.), for example. In this case, the object detection apparatus can be positioned on the roof, near the emblem, near the rear-view mirror, inside the headlights of the vehicle, etc.

The controller 1 controls the overall operation of the object detection apparatus, and is configured to include a measurement control unit 10, a deflection control unit 11, a lighting control unit 12, a distance measurement unit 13, and a communication unit 14. This controller 1 can be realized by using a computer system equipped with a CPU, ROM, RAM, etc., for example, and having the computer system execute a predetermined operating program.

The measurement control unit 10 controls the operation of the deflection control unit 11, the lighting control unit 12, and the distance measurement unit 13, and also controls the communication unit 14 to transmit point group information, which is the measurement result of the distance measurement unit 13, to an external device (not shown).

The deflection control unit 11 controls the MEMS mirror 22 via the MEMS driver 20 of the scanning light source unit 2 so that it periodically deflects in a specified angle change pattern (typically a raster scan with uniform scanning line spacing).

The lighting control unit 12 controls a light source driver 21 so that a light source LS emits laser light under the pulse conditions specified by the measurement control unit 10.

The distance measurement unit 13 measures the distance to an object in the target space based on time difference between the time of emission and the time of reception of the laser light, using the timing of the instruction to generate laser light from the lighting control unit 12 and the light receiving signal obtained from the light receiving circuit 33 of the light receiving unit 3. Further, three-dimensional position of the object is also detected by the measurement control unit 10 based on the time of emission and the time of reception of the laser light.

The communication unit 14 transmits the obtained point group information (a collection of three-dimensional positions) to an external device (not shown).

The scanning light source unit 2 generates a narrow-angle laser light and emits the laser light in various directions within a predetermined range, and is configured to include a MEMS driver 20, a light source driver 21, a MEMS mirror 22, a light source LS, and a plurality of dichroic mirrors R.

The MEMS driver 20 is connected to the MEMS mirror 22, and under the control of the deflection control unit 11 of the controller 1, generates a drive signal that controls the operation of the MEMS mirror 22 and supplies it to the MEMS mirror 22.

The light source driver 21 is connected to the light source LS, and under the control of the lighting control unit 12 of the controller 1, generates a drive signal that controls the operation of the light source LS and supplies it to the light source LS.

The MEMS mirror 22 is a deflector that has a reflective surface and is configured to be rotatable in two orthogonal directions. This MEMS mirror 22 is disposed so that the laser lights emitted from the light source LS can be incident on the reflective surface from different directions, and rotates based on a drive signal supplied from the MEMS driver 20 in order to scan each laser light within the target space. Each laser light is emitted to the external target space from an opening 23 appropriately provided in the scanning light source unit 2.

The light source LS is configured to include a plurality of light-emitting units, each of which generates a plurality of laser lights of narrow-angle beams (beams with small divergence angles) as detection light based on a control signal from the lighting control unit 12, and emits each laser light (pulsed light). For example, each of the plurality of light-emitting units is a laser diode element. The laser light emitted from each light-emitting unit of the light source LS is a beam with a divergence angle that is comparable to (that is, the same as or smaller than) the angular resolution of the object detection apparatus. Each light-emitting unit of the light source LS can be a near-infrared photonic crystal laser (PCSEL), but is not limited thereto, and any light source LS that can emit a narrow-angle beam of detection light can be used.

The plurality of light-emitting units included in the light source LS includes a first light-emitting unit with predetermined optical characteristics and a second light-emitting unit with optical characteristics different from that of the first light-emitting units. For example, the first light-emitting unit and the second light-emitting unit may have different emission wavelengths or different polarization directions. The light source LS of the present embodiment has two of first light-emitting units and two of second light-emitting units, each with different emission wavelengths.

The light receiving unit 3 receives the reflected light produced by each laser light emitted from the light source LS and generates a light receiving signal, and is configured to include a lens 30, an optical filter 31, a photodetector (light receiving element) 32, and a light receiving circuit 33. This light receiving unit 3 may be configured as a coaxial optical system that receives light along the same optical path as the optical path from the light source LS to the MEMS mirror 22, or it may be configured as a non-coaxial optical system that does not use the same optical path.

The lens 30 collects the reflected light produced by the laser light emitted from the light source LS. The optical filter 31 blocks the light which is in a different wavelength range from the laser light emitted from the light source LS and transmits the light which is in the same wavelength range as the laser light emitted from the light source LS. The photodetector 32 detects the light incident through the optical filter 31.

The light receiving circuit 33 generates a light receiving signal by performing predetermined signal processing (e.g., amplification, frequency filtering, etc.) on the output of the photodetector 32. The generated light receiving signal is supplied to the distance measurement unit 13 of the controller 1.

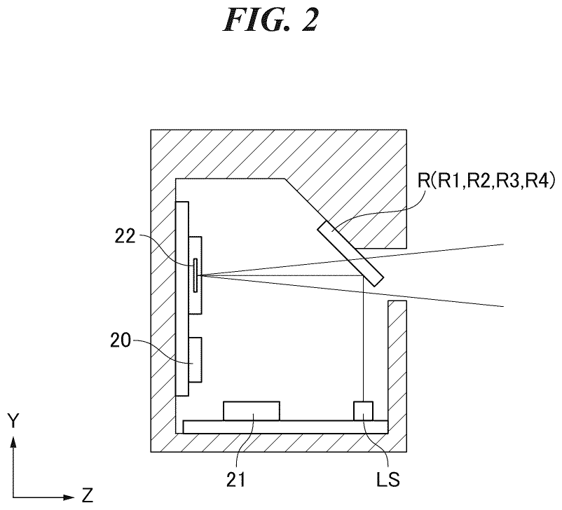

FIG. 2 is a diagram for explaining a layout example of the scanning light source unit in a housing. In the housing of the scanning light source unit 2 of the illustrated configuration example, a substrate carrying a MEMS driver 20 and a MEMS mirror 22 is disposed on the side in the figure, a substrate carrying a light source driver 21 and the light source LS is disposed on the bottom in the figure, and each dichroic mirror R is disposed obliquely on the side facing the MEMS mirror 22. The MEMS driver 20 does not necessarily have to be on the same substrate as the MEMS mirror 22, and may be a separate body, although this increases the size of the housing. The housing has an opening through which the light reflected by the MEMS mirror 22 and emitted from the scanning light source unit 2 passes. The housing is made of aluminum, for example. The housing is preferably black anodized to prevent noise caused by ambient light, etc. Each substrate is fixed to the housing by screws, for example. The plurality of dichroic mirrors R are fixed to the housing by adhesive, for example.

The light source LS includes a plurality of light-emitting units LS1, LS2, LS3, and LS4 arranged in the depth direction of the sheet in FIG. 2. The plurality of dichroic mirrors R includes dichroic mirrors R1, R2, R3, and R4 arranged in the depth direction of the sheet in FIG. 2. Each dichroic mirror R1, R2, R3, and R4 is disposed at a position where any one of the laser lights emitted from each light-emitting unit of the light source LS can be incident. The MEMS mirror 22 is disposed at a position where the laser light incident on and reflected by each dichroic mirror R1, R2, R3, and R4 can be incident. In detail, the light source LS and each of the dichroic mirrors R1, etc. are disposed so that the laser light emitted from each of the light-emitting units LS1, etc. of the light source LS is emitted in the Y direction in the figure and enters one of the dichroic mirrors R1, etc. Each of the dichroic mirrors R1, etc. is disposed at a position and angle where the incident light from each of the light-emitting units LS1, etc. is reflected and enters the MEMS mirror 22. Further, each of the dichroic mirrors R1, etc. is disposed at a position where any one of the lights reflected by the MEMS mirror 22 enters. Therefore, a part of each of the dichroic mirrors R1, etc. is disposed to cover the opening of the housing. Further, the MEMS mirror 22 is disposed so that the laser light reflected by each of the dichroic mirrors RI etc. travels in the Z direction in the figure, that is, in the direction toward the opening of the housing, and enters the opening.

The laser light can be scanned by deflecting the MEMS mirror 22. For example, the laser light traveling in the Z direction shown in the figure is scanned up and down in the Y direction. The trajectory of the laser light becomes the irradiation area. A part of the irradiation area includes the positions of the dichroic mirrors R1, etc. as shown in the figure. The light reflected by the MEMS mirror 22 and incident on the dichroic mirrors R1, etc. transmits through the dichroic mirrors R1, etc. and proceeds from inside the housing of the scanning light source unit 2 to the outside. Here, when the laser light transmits through the dichroic mirrors R1, etc., the light path of the laser light is shifted from the light path before it enters due to internal refraction. However, since this shift in the light path is approximately the thickness of the dichroic mirrors R1, etc., it does not affect the distance measurement performance and can be corrected at the light receiving unit 3 side.

Here, each dichroic mirror R1, R2, R3, R4 is configured by laminating several to several hundred layers of thin films of high reflective refractive index materials such as titanium oxide, tantalum oxide, niobium oxide, etc., and thin films of low reflective refractive index materials such as silicon oxide and magnesium fluoride on a glass substrate based on a predetermined optical design. In the present embodiment, each of the dichroic mirrors R1, etc. is configured by laminating the above-described thin films on a glass substrate, and is configured to have a size of a short side of about 3 mm, a long side of about 8 mm, and a thickness of about 1 mm, for example. And a portion of about 3 to 4 mm along the long side is bonded and fixed to a slope provided in a position facing the MEMS mirror 22 inside the housing of the scanning light source unit 2, and the remaining portion not fixed to this slope is disposed to hang down from the slope. A photocurable resin or a thermosetting resin can be used to bond the dichroic mirrors R1, etc.

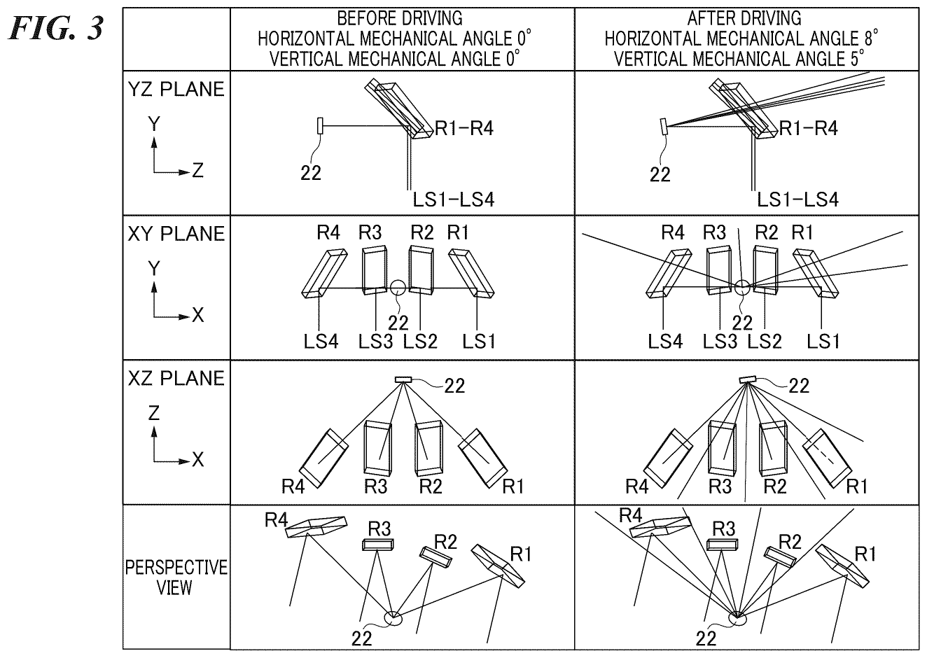

FIG. 3 is a diagram for explaining in detail the arrangement of each dichroic mirror and the MEMS mirror. In the diagram, from the top to the bottom, a layout diagram in YZ coordinate (YZ plane), a layout diagram in XY coordinate (XY plane), a layout diagram in XZ coordinate (XZ plane), and a perspective view are shown. The Y-axis and Z-axis here correspond to the respective axes in FIG. 2 described above, and the X-axis corresponds to the direction perpendicular to each of the Y-axis and Z-axis in FIG. 2 described above. Further, “BEFORE DRIVING” refers to the trajectory of the laser light that is incident on and reflected by each of the dichroic mirrors R1, etc. when the MEMS mirror 22 is at a reference position with a horizontal mechanical angle (deflection angle) of 0° and a vertical mechanical angle (deflection angle) of 0°. And “AFTER DRIVING” refers to the trajectory of the laser light that is incident on and reflected by each of the dichroic mirrors R1, etc. when the MEMS mirror 22 is at the maximum mechanical angle in the present embodiment with a horizontal mechanical angle (deflection angle) of 8° and a vertical mechanical angle (deflection angle) of 5°. Furthermore, hereinafter, the four light-emitting units of the light source LS are distinguished as LS1, LS2, LS3, and LS4, respectively. Each of the light-emitting units LS1, etc. is located below each of the dichroic mirrors R1, etc. on the sheet in FIG. 3 (not shown, only the symbols are shown).

As shown in the layout diagrams of the XY plane and the XZ plane, the dichroic mirrors R1 to R4 are arranged at intervals along the X direction. In the layout diagrams of the XY plane and the YZ plane, the laser light emitted from each light-emitting unit LS1 to LS4 is emitted from below each of the dichroic mirrors R1, etc., and enters each of the dichroic mirrors R1, etc., and then enters the MEMS mirror 22. In the XY plane, the MEMS mirror 22 is arranged further back than each of the dichroic mirrors R1, etc., and in the YZ plane, the MEMS mirror is arranged relatively to the left of each of the dichroic mirrors R1, etc.

The laser light reflected by the MEMS mirror 22 either transmits through each of the dichroic mirrors R1, etc., or transmits through the gaps between each of the dichroic mirrors R1, etc. The former is shown in the layout diagram of the XZ plane of “BEFORE DRIVING”, and the latter is shown in the layout diagram of the XZ plane of “AFTER DRIVING”. When the MEMS mirror 22 is deflected, the laser light enters and transmits through each of the dichroic mirrors R1, etc. up to a certain deflection angle, and at a deflection angle beyond the certain angle, the laser light transmits through the gaps between each of the dichroic mirrors R1, etc. The reason why the laser light transmits through each of the dichroic mirrors R1, etc. will be described next.

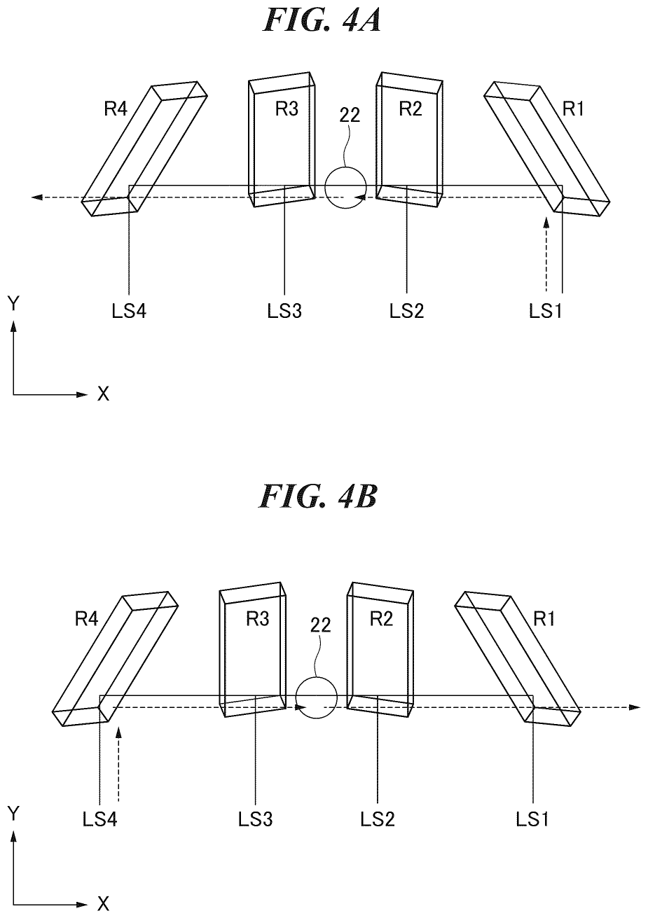

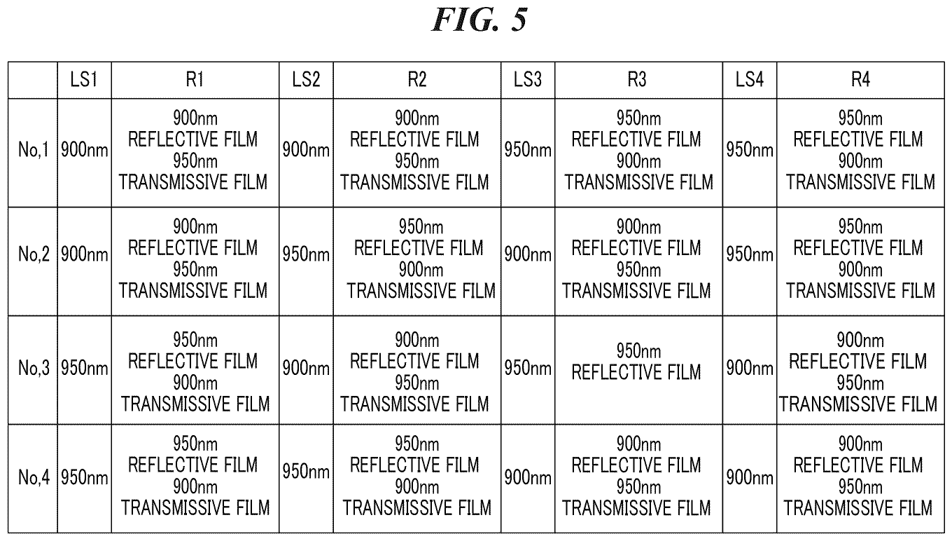

FIGS. 4A and 4B are diagrams for explaining in more detail the relationship between each dichroic mirror and the trajectory of the laser light when the laser light transmits through each dichroic mirror. FIG. 5 is a diagram showing a combination example the transmission/reflection of characteristics of each dichroic mirror and the wavelength of each light-emitting unit. In the present embodiment, for example, four combinations as shown in FIG. 5 can be considered. In this case, the combination of light-emitting unit LS1 and light-emitting unit LS4 forms a pair, and the combination of light-emitting unit LS2 and light-emitting unit LS3 forms a pair. The wavelengths of each of the light-emitting units LS1, etc. are merely examples and are not limited thereto, but it is more preferable that there is a difference of 50 nm or more in each combination. In the following, the combination example No. 1 shown in FIG. 5 will be described.

As shown by the dotted line in FIG. 4A, a laser light (first light) having a wavelength of 900 nm emitted from light-emitting unit LS1 is incident on and reflected by dichroic mirror R1 having reflection characteristics for wavelengths of 900 nm or less, and is reflected by the MEMS mirror 22. Thereafter, the laser light transmits through dichroic mirror R4 having reflection characteristics for wavelengths of 950 nm or less and transmission characteristics for a wavelength of 900 nm, and is irradiated to the outside of the scanning light source unit 2.

As shown by the dotted line in FIG. 4B, the laser light (second light) having a wavelength of 950 nm emitted from light-emitting unit LS4 is incident on and reflected by dichroic mirror R4 having reflection characteristics for wavelengths of 950 nm or less, and is reflected by the MEMS mirror 22. Thereafter, the laser light transmits through dichroic mirror R1 having reflection characteristic for wavelengths of 900 nm or less and transmission characteristics for wavelengths of 950 nm or more, and is irradiated to the outside of the scanning light source unit 2.

The same applies to the relationship between light-emitting unit LS2 and dichroic mirror R2. The laser light with a wavelength of 900 nm emitted from light-emitting unit LS2 is incident on and reflected by dichroic mirror R2 having reflection characteristics for wavelengths of 900 nm or less, and is reflected by the MEMS mirror 22. Thereafter, the laser light transmits through dichroic mirror R3 having reflection characteristics for wavelengths of 950 nm or less and transmission characteristics for wavelengths of 900 nm or less, and is irradiated to the outside of the scanning light source unit 2.

The same applies to the relationship between light-emitting unit LS3 and dichroic mirror R3. The laser light with a wavelength of 950 nm emitted from light-emitting unit LS3 is incident on and reflected by dichroic mirror R3 having reflection characteristics for wavelengths of 950 nm or less, and is reflected by the MEMS mirror 22. Thereafter, the laser light transmits through dichroic mirror R2 having reflection characteristics for wavelengths of 900 nm or less and transmission characteristics for wavelengths of 950 nm or less, and is irradiated to the outside of the scanning light source unit 2.

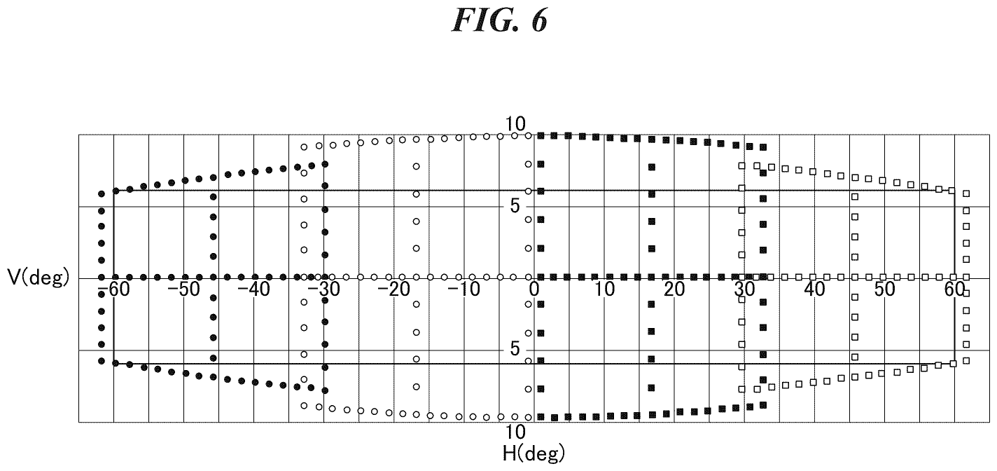

FIG. 6 is a diagram showing an example of optical calculation of the measurement field angle assuming the optical scanning apparatus of the embodiment described above. Each of the points shown in the diagram indicates a measurement point obtained using each of the light-emitting units LS1, etc. When optical calculation was performed for the MEMS mirror 22 with a horizontal mechanical angle of ±8° and a vertical mechanical angle of ±5°, it was found that the measurement viewing angle can be ensured to be ±60° in the horizontal direction and ±6° in the vertical direction as shown in the diagram. This calculation result showed that the measurement field angle can be widened while the vertical mechanical angle is made smaller than before. Here, in the diagram, the measurement points based on LS1 are shown in black circles, the measurement points based on LS2 are shown in white circles, the measurement points based on LS3 are shown in black squares, and the measurement points based on LS4 are shown in white squares. Further, the measurement points based on each of the light-emitting units are shown only along the outer edge of the measurement range and along the horizontal axis and the vertical axis at the center of the measurement range.

According to the above embodiment, it is possible to further widen measurement viewing angle in an optical scanning apparatus or the like.

Here, note that the present disclosure is not limited to the content of the above described embodiment, and various modifications can be made within the scope of the gist of the present disclosure. For example, in the above embodiment, a dichroic mirror was shown as an example of an optical element for wavelength filtering, but a bandpass filter may be used instead of the optical element or in combination with the dichroic mirror. For example, a bandpass filter with a transmission band of 25 nm that transmits wavelengths of 900 nm±12.5 nm and reflects other wavelength ranges, or a bandpass filter with a transmission band of 25 nm that transmits wavelengths of 950 nm±12.5 nm and reflects other wavelength ranges can be used.

Further, in the embodiment described above, light source LS is arranged so that laser light emitted from the light source LS travels along the Y direction, but the arrangement of the light source LS is not limited thereto, and for example, the light source LS may be arranged by rotating the substrate on which it is mounted in the X direction. In such a case, the arrangement of each of the dichroic mirrors R1, etc. may be adjusted so that the laser light is incident along the normal direction (Z direction) of the MEMS mirror 22.

Further, in the embodiment described above, the MEMS mirror 22 is arranged so that its initial tilt is 0° with respect to the Y axis, but the MEMS mirror 22 may be arranged so that it is tilted at a maximum of about 5° with respect to the Y axis. In such a case, the position of each of the dichroic mirrors R1, etc. may be adjusted so that the laser light reflected by the MEMS mirror 22 with a deflection angle of 0° travels parallel to the Z direction.

Further, in the embodiment described above, a dichroic mirror is used as an example of an optical element, but similar effect can be obtained by using a reflective polarizer as the optical element. Here, the reflective polarizer may be a polarizing beam splitter or a wire grid polarizer, for example. In this case, a reflective polarizer may be disposed in the position where each of the dichroic mirrors R1, etc. were disposed in the embodiment described above. Further, in this case, as each of the light-emitting units LS1, etc. of the light source LS, a unit capable of emitting a laser light that has a high degree of polarization and is substantially linearly polarized is used. As one example, an end-face type laser diode that shows a high degree of polarization with S wave component of 90% or more can be used. The basic configuration of the scanning light source unit 2 of the above-described modified working example 1 is similar to that shown in FIG. 1 and FIG. 2, with the only difference being that the dichroic mirrors R1, etc. are replaced with reflective polarizers and that each of the light-emitting units LS1, etc. are replaced with a unit with a high degree of polarization. Therefore, illustration of the basic configuration of modified working example 1 will be omitted.

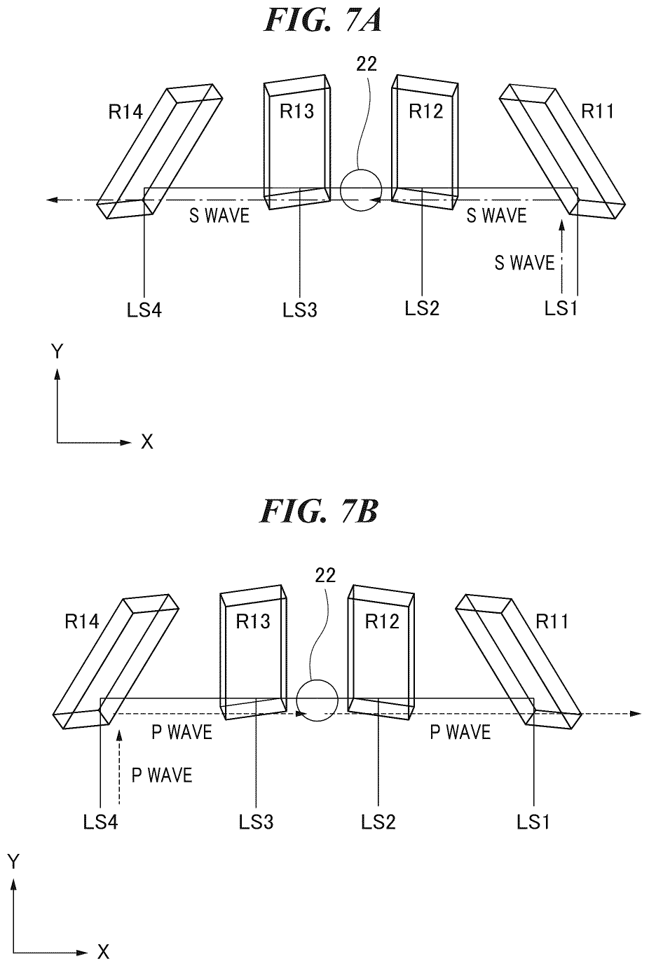

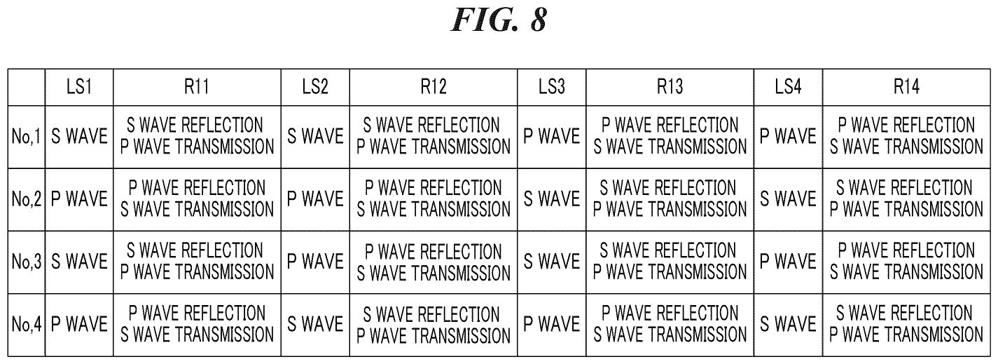

FIG. 7A and FIG. 7B are diagrams for explaining in more detail the relationship between each reflective polarizer and the trajectory of the laser light when the laser light transmits through each h reflective polarizer according to modified working example 1. FIG. 8 is a diagram showing a combination example of the transmission/reflection characteristics of each reflective polarizer and the wavelength of each of the light-emitting units according to modified working example 1. In this modified working example 1, for example, four combinations as shown in FIG. 8 can be considered. In this case, the combination of light-emitting unit LS1 and light-emitting unit LS4 forms a pair, each having a polarization direction that differs by approximately 90° from the other, and the combination of light-emitting unit LS2 and light-emitting unit LS3 forms a pair, each having a polarization direction that differs by approximately 90° from the other. The polarization direction (S wave/P wave) of each of the light-emitting units LS1, etc. is merely an example and is not limited thereto.

Each of the reflective polarizers R11, R12, R13, and R14 are respectively substituted for each of the dichroic mirrors R1, R2, R3, and R4 in the above-described embodiment. Each of the reflective polarizers R11, etc. is configured to have a size of about 3 mm on the short side, about 8 mm on the long side, and about 1 mm thick. When each of the reflective polarizers R11, etc. is a polarizing beam splitter, it is configured by laminating a dielectric multilayer film on a glass substrate or the like, and when it is a wire grid type, it is configured by providing a wire grid made of a metal such as aluminum on one side of a glass substrate or the like. And similar to the above-described embodiment, a portion of about 3 to 4 mm along the long side direction is fixed by bonding to a slope provided in a position facing the MEMS mirror 22 inside the housing of the scanning light source unit 2, and the remaining portion not fixed to this slope is arranged to hang down from the slope. When each of the reflective polarizers R11, etc. is configured with a polarizing beam splitter, each of the reflective polarizers R11, etc. is disposed at an angle such that the laser lights emitted from each of the light-emitting units LS1, etc. of the light source LS is incident at approximately 45°. To bond each of the reflective polarizers R11, etc., a photocurable resin or a thermosetting resin can be used, for example.

When the laser light is scanned by deflecting the MEMS mirror 22, a part of the irradiation area includes the position of the reflective polarizer R11, etc., as in the above embodiment. The light reflected by the MEMS mirror 22 and incident on the reflective polarizer R11, etc., transmits through the reflective polarizer R11, etc., and proceeds from inside the housing of the scanning light source unit 2 to the outside. When transmitting through the inside of the reflective polarizer R11, etc., the laser light is refracted inside, causing the optical path to shift from the path before it enters, but since this optical path shift is about the thickness of the reflective polarizer R11, etc., it does not affect the distance measurement performance and can be corrected at the light receiving unit 3 side.

Hereinafter, the operation of the scanning light source unit 2 of modified working example 1 will be described using combination No. 1 shown in FIG. 8 as an example, and note that the concept is similar for combinations No. 2 to No. 4.

As shown by the dashed line in FIG. 7A, the S wave laser light (first light) emitted from light-emitting unit LS1 is incident on and reflected by reflective polarizer R11 that has a reflection characteristics for S waves, and after being reflected by the MEMS mirror 22, transmits through reflective polarizer R14 having transmission characteristics for S waves, and is irradiated to the outside of the scanning light source unit 2.

Further, as shown by the dotted line in FIG. 7B, the P wave laser light (second light) emitted from light-emitting unit LS4 is incident on and reflected by reflective polarizer R14 having reflection characteristics for P waves, and after being reflected by the MEMS mirror 22, transmits through reflective polarizer R11 having transmission characteristics for P waves, and is irradiated to the outside of the scanning light source unit 2.

The same applies to the relationship between light-emitting unit LS2 and reflective polarizer R12. The S wave laser light emitted from light-emitting unit LS2 is incident on and reflected by reflective polarizer R12 having reflection characteristics for S waves, and after being reflected by the MEMS mirror 22, transmits through reflective polarizer R13 having transmission characteristics for S waves, and is irradiated to the outside of the scanning light source unit 2.

The same applies to the relationship between light-emitting unit LS3 and reflective polarizer R13. The P wave laser light emitted from light-emitting unit LS3 is incident on and reflected by reflective polarizer R13 having reflection characteristics for P waves, and after being reflected by the MEMS mirror 22, transmits through reflective polarizer R12 having transmission characteristics for P waves, and is irradiated to the outside of the scanning light source unit 2.

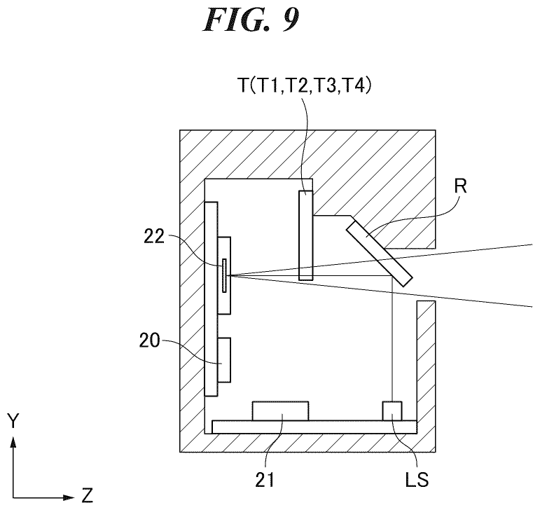

Further, the optical scanning apparatus of modified working example 2 can be obtained by further combining a ¼ wavelength plate with the configuration of modified working example 1 described above. Here, the ¼ wavelength plate is a wavelength plate capable of converting incident linearly polarized light into circularly polarized light, or converting incident circularly polarized light into linearly polarized light. The scanning light source unit 2 of modified working example 2 has a configuration in which each of the dichroic mirrors R1, etc. in the configuration shown in FIG. 1 and FIG. 2 is replaced with a reflective polarizer, and each of the light-emitting units LS1, etc. is replaced with a unit with a high degree of polarization (the configuration of modified working example 1). As FIG. 9 shows a layout example inside the housing of the scanning light source unit, ¼ wavelength plates T (T1, T2, T3, T4) are arranged between the plurality of reflective polarizers R and the MEMS mirror 22. In the example shown, the ¼ wavelength plates are glued and fixed to the upper part of the housing, and are arranged so as to hang down. Photocurable resin or thermosetting resin can be used to glue the ¼ wavelength plates T, for example.

Each of the reflective polarizers R in this modified working example 2 is configured to have a size of, for example, a short side of about 1 mm, a long side of about 8 mm, and a thickness of about 1 mm, and a portion of 3 to 4 mm in the long side direction is glued and fixed to the housing. The ¼ wavelength plates T are also configured to have a similar size as the reflective polarizers R. The reason why the width (short side) of both the reflective polarizers R and the ¼wavelength plates T are small is that when deflected by the MEMS mirror 22, the incident angle of the laser light when it enters the reflective polarizers R and the ¼ wavelength plates T changes, causing the polarization direction of the laser light to shift, making it difficult to polarize by the reflective polarizers R, thereby the incidence of such a laser light with a large incident angle on the reflective polarizers R, etc. is reduced.

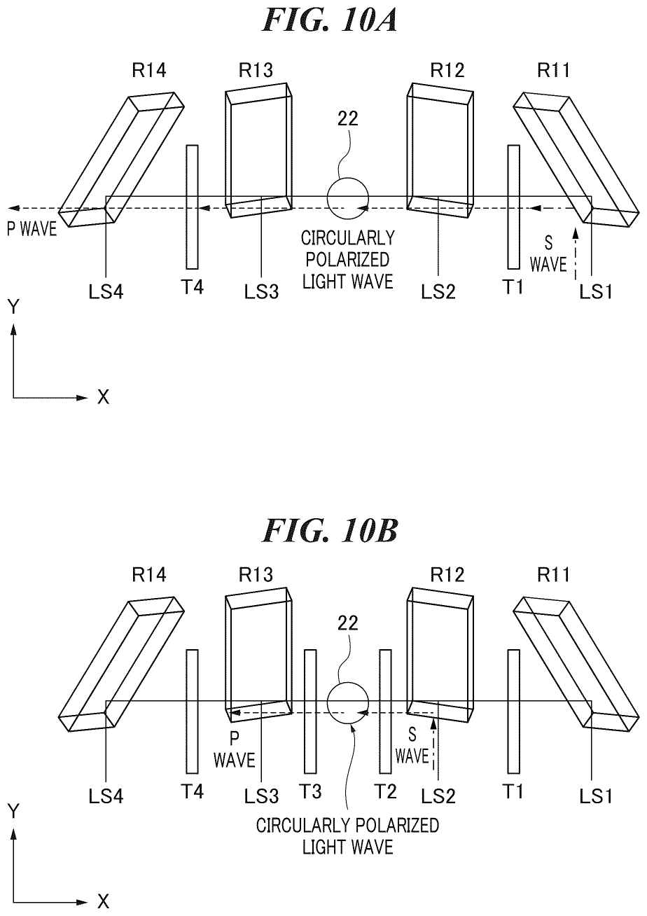

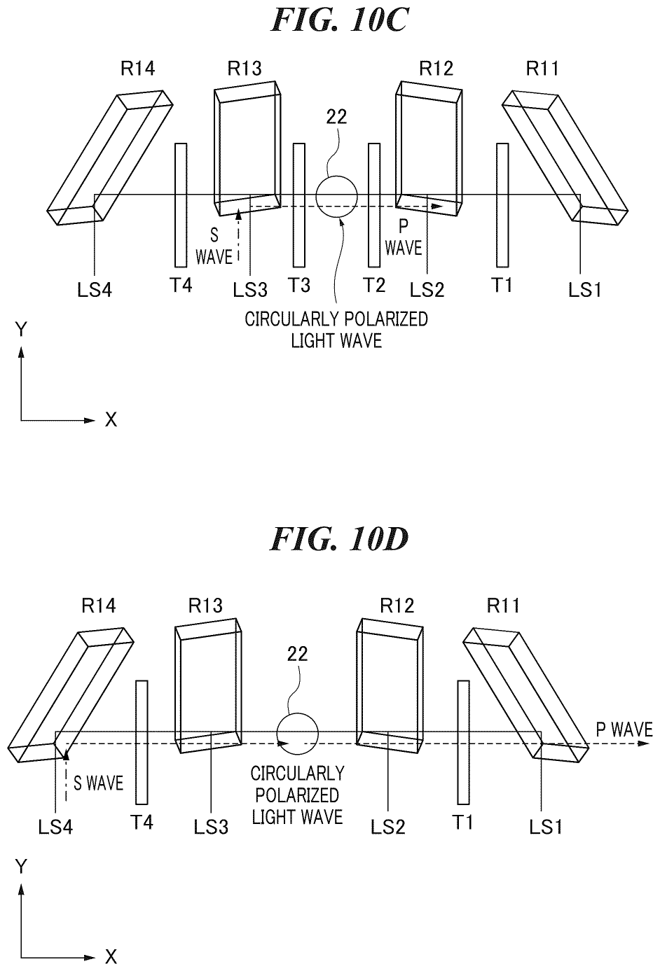

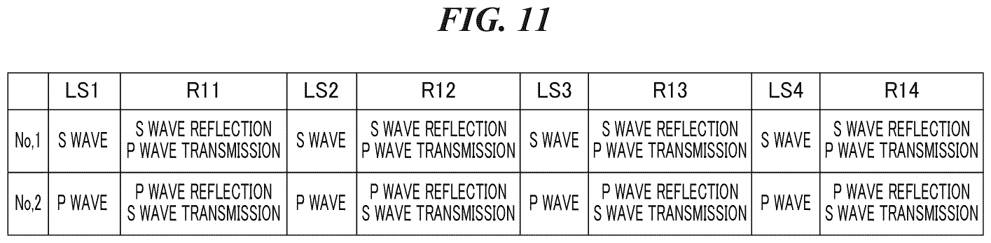

FIG. 10A to FIG. 10D are diagrams for explaining in more detail the relationship between each reflective polarizer and the trajectory of the laser light when the laser light transmits through each reflective polarizer according to modified working example 2. FIG. 11 is a diagram showing a combination example of the transmission/reflection characteristics of each reflective polarizer and the wavelength of each light-emitting unit according to modified working example 2. In this modified working example 2, for example, two combinations as shown in FIG. 11 can be considered. In this case, light-emitting units LS1 to LS4 may all be of one type that emits s-wave laser lights, and reflective polarizers R11 to R14 may all be of one type that has the characteristics of transmitting P waves.

Hereinafter, the operation of the scanning light source unit 2 of modified working example 2 will be described using combination No. 1 shown in FIG. 11 as an example, and note that the concept is similar for combination No. 2.

As shown by the dotted line in FIG. 10A, the S wave laser light emitted from light-emitting unit LS1 is incident on and reflected by reflective polarizer R11 having reflection characteristics for S waves, transmits through ¼ wavelength plate T1 arranged between the MEMS mirror 22 and reflective polarizer R11, where it is converted into a circularly polarized light, and is incident on the MEMS mirror 22, then is reflected by the MEMS mirror 22. Thereafter, the laser light transmits through ¼ wavelength plate T4, where it is converted into a P wave linearly polarized light, transmits polarizer through reflective R14 having transmission characteristics for P waves, and is irradiated to the outside of the scanning light source unit 2. The ¼ wavelength plates T1 and T4 are arranged so that the light emitted from light-emitting unit LS1 is incident on them approximately perpendicularly. Here, in FIG. 10A, ¼ wavelength plate T2 and ¼ wavelength plate T3 are omitted for ease of explanation. Further, the ¼ wavelength plates T2 and T3 are disposed at positions that do not overlap with the optical path of the light emitted from light-emitting unit LS1.

Further, as shown by the dotted line in FIG. 10D, the S wave laser light emitted from light-emitting unit LS4 is incident on and reflected by reflective polarizer R14 having reflection characteristics for S waves, transmits through ¼ wavelength plate T4 arranged between the MEMS mirror 22 and reflective polarizer R14, where it is converted into a circularly polarized light, and is incident on the MEMS mirror 22, then is reflected by the MEMS mirror 22. Thereafter, the laser light transmits through ¼ wavelength plate T1 where it is converted into a P wave linearly polarized light, transmits through reflective polarizer R11 having transmission characteristics for P waves, and is irradiated to the outside of the scanning light source unit 2. The ¼ wavelength plates T1 and T4 are disposed so that the light emitted from light-emitting unit LS4 is incident on them approximately perpendicularly. Here, in FIG. 10D, the ¼ wavelength plate T2 and the ¼ wavelength plate T3 are omitted for ease of explanation. Further, the ¼ wavelength plates T2 and T3 are disposed at positions that do not overlap with the optical path of the light emitted from light-emitting unit LS4.

The same applies to the relationship between light-emitting unit LS2 and reflective polarizer R12. As shown by the dotted line in FIG. 10B, the S wave laser light emitted from light-emitting unit LS2 is incident on and reflected by reflective polarizer R12 having reflection characteristics for S waves, transmits through ¼ wavelength plate T2 arranged between the MEMS mirror 22 and reflective polarizer R12, where it is converted into a circularly polarized light, and is incident on the MEMS mirror 22, then is reflected by the MEMS mirror 22. Thereafter, the laser light transmits through ¼ wavelength plate T3 where it is converted into P wave linearly polarized light, transmits through reflective polarizer R13 having transmission characteristics for P waves, and is irradiated to the outside of the scanning light source unit 2. The ¼ wavelength plates T2 and T3 are disposed so that the light emitted from light-emitting unit LS2 is incident on them approximately perpendicularly. Here, the ¼ wavelength plates T1 and T4 are disposed at positions that do not overlap with the optical path of the light emitted from light-emitting unit LS2.

The same applies to the relationship between light-emitting unit LS3 and reflective polarizer R13. As shown by the dotted line in FIG. 10C, the S wave laser light emitted from light-emitting unit LS3 is incident on and reflected by reflective polarizer R13 having reflection characteristics for S waves, transmits through ¼ wavelength plate T3 arranged between the MEMS mirror 22 and reflective polarizer R13, where it is converted into a circularly polarized light, and is incident on the MEMS mirror 22, then is reflected by the MEMS mirror 22. Thereafter, the laser light transmits through ¼ wavelength plate T2, where it is converted into P wave linearly polarized light, transmits through reflective polarizer R13 having transmission characteristic for P waves, and is irradiated to the outside of the scanning light source unit 2. The ¼ wavelength plates T2 and T3 are disposed so that the light emitted from light-emitting unit LS3 is incident on them approximately perpendicularly. Here, the ¼ wavelength plates T1 and T4 are disposed at positions that do not overlap with the optical path of the light emitted from light-emitting unit LS3.

Here, in each of modified working examples 1 and 2, a flat reflective polarizer has been described, but a cube-shaped beam splitter may also be used. In this case, there is an advantage that the optical path length does not shift.

The present application is based on, and claims priority from, JP Application Serial Number, 2024-4461 filed on Jan. 16, 2024, the disclosure of which is hereby incorporated by reference herein in its entirety.

### DESCRIPTION OF SYMBOLS

1: Controller
2: Scanning light source unit (Optical scanning apparatus)
3: Light receiving unit
10: Measurement control unit
11: Deflection control unit
12: Lighting control unit
13: Distance measurement unit
14: Communication unit
20: MEMS driver
21: Light source driver
22: MEMS mirror
30: Lens
31: Optical filter
32: Photodetector (Light receiving element)
33: Light receiving circuit
LS: Light source
LS1, LS2, LS3, LS4: Light-emitting unit
R: Optical elements (Plurality of dichroic mirrors/reflective polarizers)
R1, R2, R3, R4: Dichroic mirror
R11, R12, R13, R14: Reflective polarizer
T, T1, T2, T3, T4: ¼ wavelength plate

What is claimed is:

1. An optical scanning apparatus used for detecting an object by irradiating light and receiving the reflected light comprising:
a deflector;
a light source having at least a first light-emitting unit that emits a first light and a second light-emitting unit that emits a second light having optical characteristics different from that of the first light;
a first optical element disposed so that the first light emitted from the first light-emitting unit is incident thereon and reflects the first light and causes it to be incident on the deflector;
a second optical element disposed so that the second light emitted from the second light-emitting unit is incident thereon and reflects the second light and causes it to be incident on the deflector;
wherein the first optical element has optical characteristics of reflecting the first light and transmitting the second light, and
wherein the second optical element has optical characteristics of reflecting the second light and transmitting the first light.

2. The optical scanning apparatus according to claim 1,
wherein the first light and the second light have different wavelengths as the optical characteristics,
wherein the first optical element is a first dichroic mirror that reflects the first light and transmits the second light, and
wherein the second optical element is a second dichroic mirror that reflects the second light and transmits the first light.

3. The optical scanning apparatus according to claim 1,
wherein the first light and the second light have different wavelengths as the optical characteristics,
wherein the first optical element is a first bandpass filter that reflects the first light and transmits the second light, and
wherein the second optical element is a second bandpass filter that reflects the second light and transmits the first light.

4. The optical scanning apparatus according to claim 2,
wherein the difference in wavelength between the first light and the second light is 50 nm or more.

5. The optical scanning apparatus according to claim 1,
wherein the first light and the second light have different polarization directions as the optical characteristics,
wherein the first optical element is a first reflective polarizer that reflects the first light and transmits the second light, and
wherein the second optical element is a second reflective polarizer that reflects the second light and transmits the first light.

6. The optical scanning apparatus according to claim 5,
wherein the difference in polarization direction between the first light and the second light is approximately 90°.

7. The optical scanning apparatus according to claim 5,
wherein the first light-emitting unit emits linearly polarized light as the first light, and
wherein the second light-emitting unit emits linearly polarized light as the second light.

8. An optical scanning apparatus used for detecting an object by irradiating light and receiving the reflected light comprising:
a deflector;
a light source having at least a first light-emitting unit and a second light-emitting unit in which each unit emits a first linearly polarized light;
a first reflective polarizer disposed so that the first linearly polarized light emitted from the first light-emitting unit is incident thereon, the first reflective polarizer reflecting the first linearly polarized light from the first light-emitting unit, and causes to transmit a second linearly polarized light whose polarization direction is different from that of the first linearly polarized light by approximately 90°;
a second reflective polarizer disposed so that the first linearly polarized light emitted from the second light-emitting unit is incident thereon, the second reflective polarizer reflecting the first linearly polarized light from the second light-emitting unit, and causes to transmit a second linearly polarized light whose polarization direction is different from that of the first linearly polarized light by approximately 90°;
a first ¼ wavelength plate disposed between the first reflective polarizer and the deflector; and
a second ¼ wavelength plate disposed between the second reflective polarizer and the deflector;
wherein the first linearly polarized light reflected by the first reflective polarizer transmits through the first ¼ wavelength plate and is converted into circularly polarized light, is incident on and reflected by the deflector, is then converted into the second linearly polarized light by entering and transmitting through the second ¼ wavelength plate, and is incident on and transmitted through the second reflective polarizer, and
wherein the first linearly polarized light reflected by the second reflective polarizer transmits through the second ¼ wavelength plate and is converted into circularly polarized light, is incident on and reflected by the deflector, is then converted into the second linearly polarized light by entering and transmitting through the first ¼ wavelength plate, and is incident on and transmitted through the first reflective polarizer.

9. An object detection apparatus comprising:
an optical scanning apparatus according to claim 1;
a light receiving unit that detects the reflected light caused by the light irradiated from the optical scanning apparatus and generates a light receiving signal corresponding to the intensity of the reflected light; and
a control unit that controls the operation of the optical scanning apparatus and generates point group information based on the light receiving signal.

10. The optical scanning apparatus according to claim 3,
wherein the difference in wavelength between the first light and the second light is 50 nm or more.

11. An object detection apparatus comprising:
an optical scanning apparatus according to claim 8;
a light receiving unit that detects the reflected light caused by the light irradiated from the optical scanning apparatus and generates a light receiving signal corresponding to the intensity of the reflected light; and
a control unit that controls the operation of the optical scanning apparatus and generates point group information based on the light receiving signal.
